(19) United States
(12) Patent Application Publication
(10) Pub. No.: US 2021/0174274 A1
(43) Pub. Date: Jun. 10, 2021

(54) SYSTEMS AND METHODS FOR MODELING ORGANIZATIONAL ENTITIES

(71) Applicant: UST Global Inc., Aliso Viejo, CA (US)

(72) Inventors: Ratheesh Raveendran Nair, Cumming, GA (US); Sathish Kumar Mohanraj, Alpharetta, GA (US); Firoz Abdul Rasheed, Alpharetta, GA (US); Anees Mytheenkutty, Alpharetta, GA (US)

(21) Appl. No.: 16/912,743

(22) Filed: Jun. 26, 2020

(30) Foreign Application Priority Data
Dec. 5, 2019 (IN) 201911050191

(51) Int. Cl. G06Q 10/06; G06N 20/00; G06K 9/62

(52) U.S. Cl. CPC G06Q 10/0633; G06Q 10/06316; G06K 9/6276; G06N 20/00; G06Q 10/067

(57) ABSTRACT

A system for displaying an organization model is configured to: (a) retrieve work items from storage, each work item including at least one requirement; (b) determine, for each of the work items, one or more dependencies; (c) determine a relative ranking of costs for the work items; and (d) provide, to a client device, visualization parameters for representing the work items. For a respective work item, the visualization parameters include a first visual indicator representing a type of work item, a second visual indicator representing a cost of delay associated with the work item, and a third visual indicator representing a cost of delay profile for the work item. The visualization parameters further include a fourth visual indicator for linking pairs of work items to indicate a dependency between the linked work items.

### CROSS-REFERENCE TO RELATED APPLICATIONS

This application claims the benefit of Indian Provisional Application No. 201911050191, filed Dec. 5, 2019, which is herein incorporated by reference in its entirety.

### TECHNICAL FIELD

The present disclosure relates to developing virtual models of an organization and more specifically to systems and methods for generating virtual models of an organization for identifying areas of improvement and managing workflow changes within the organization.

### BACKGROUND

Digital disruption affects most industries across the world. In order to meet ever-growing demands of competition and customer satisfaction, many organizations have adopted different approaches to improvement. Some of these approaches include a digital transformation of normal business procedures to promote organizational agility for achieving goals of the organization. An organization, in general, has different goals or pressures at various times depending on where the organization is within an organizational life cycle. Example goals and/or pressures organizations may face include generating revenue, increasing market share, improving customer service, reducing operating cost, reducing “time to market” for products, reducing uncertainty, improving predictability in product or service deliverables, and so on.

Organizations adopt approaches to improvement in order to achieve one or more of the aforementioned goals. Organizations spend resources in training, restructuring, engaging external support systems, etc. These activities can sometimes yield poorer results than before the activities were undertaken. The present disclosure provides systems and methods for creating virtual models of an organization to help mitigate problems associated with inefficiencies arising from the organization's structure.

### SUMMARY

According to some implementations of the present disclosure, a system for displaying an organization model is provided. The system includes a non-transitory computer-readable medium storing computer-executable instructions thereon such that when the instructions are executed, the system is configured to: (a) retrieve work items from storage, each work item including at least one requirement; (b) determine, for each of the work items, one or more dependencies; (c) determine a relative ranking of costs for the work items; and (d) provide, to a client device, visualization parameters for representing the work items. For a respective work item, the visualization parameters include a first visual indicator representing a type of work item, a second visual indicator representing a cost of delay associated with the work item, and a third visual indicator representing a cost of delay profile for the work item. The visualization parameters further include a fourth visual indicator for linking pairs of work items to indicate a dependency between the linked work items.

According to some implementations of the present disclosure, a method for displaying an organization model is provided. Work items are retrieved from storage, each work item including at least one requirement. One or more dependencies are determined for each of the work items. A relative ranking of costs for the work items is determined. Visualization parameters for representing the work items are provided to a client device. For a respective work item, the visualization parameters include a first visual indicator representing a type of work item, a second visual indicator representing a cost of delay associated with the work item, and a third visual indicator representing a cost of delay profile for the work item. The visualization parameters further include a fourth visual indicator for linking pairs of work items to indicate a dependency between the linked work items.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 illustrates a block diagram of a system for developing a computer model of an organization, according to some implementations of the present disclosure;

FIG. 2 illustrates a visualization of an organization model according to some implementations of the disclosure;

FIG. 3A illustrates a first state of an organization model, according to some implementations of the present disclosure;

FIG. 3B illustrates a second state of the organization model of FIG. 3A;

FIG. 4 illustrates a table showing example results of a Monte-Carlo analysis on work items according to some implementations of the present disclosure;

FIG. 5 illustrates a ranking graph according to some implementations of the present disclosure;

FIG. 6 illustrates a block cluster interface for insight analysis according to some implementations of the present disclosure;

FIG. 7 is a flow diagram illustrating a process for displaying several metrics according to some implementations of the present disclosure;

FIG. 8 is a flow diagram illustrating a process for generating a model for an organization according to some implementations of the present disclosure;

FIG. 9 illustrates a screenshot of a website showing an example of requirement analysis according to some implementations of the present disclosure;

FIG. 10 provides an example training set for requirement analysis according to some implementations of the present disclosure;

FIG. 11A illustrates an example duration graph used for duration approximation according to some implementations of the present disclosure;

FIG. 11B illustrates an example duration graph used for duration approximation according to some implementations of the present disclosure; and

FIG. 12 provides sample training data for “risk” or “no-risk” classification for training a machine learning model.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Organizations face many challenges when it comes to adapting and positioning for a changing environment. Survey results of global enterprise organizations' agile adoption maturity and organizational challenges have been previously conducted. Results show that about 6% of organizations admit that agile practices enable greater adaptability to market conditions, 12% admit to having high level of competency with agile practices across the organization, 53% admit to using agile practices, 21% admit to experimenting with agile practices in controlled units, 5% admit to considering an agile initiative, and 4% admit to having no agile initiatives. Organizations can be analogized with organisms in that resources are necessary for an organism to survive. As the organism survives in its environment, the organism adapts to changes within the environment. Adaptation can involve internal changes within the organism or fashioning external resources to achieve one or more goals of the organism. Organisms are usually unaware of specific internal changes that occur when adapting to an environment. Organizations, on the other hand, usually undergo directed or planned internal restructuring to purposefully adapt to a changing environment. The directed restructuring can sometimes be ill-informed or purely reactionary, not taking into account a totality of a present state of the organization.

Hence, embodiments of the present disclosure provide systems and methods for harvesting valuable insights from gathered knowledge in order to help an organization achieve one or more goals. Embodiments of the present disclosure provide a platform that enables agile product and service delivery management. The platform continuously learns and harvests valuable insights from the organization's product or service deliverables. An example of a service deliverable includes knowledge work of a team or an individual within the organization.

The platform can provide visibility as to “who”, “what”, “why”, and “when”. In some organizations, organizational structure does not necessarily match working relationships. As such, some individuals may operate under an assumption that the organizational structure reflects reality. This misinformation can harm overall efficiency within the organization, making the organization seem opaque to its own employees. The platform can react to constant business demands; predict risks and resolving dependencies; provide insights, feedback and improvements; enhance predictability; and improve agile adoption. The platform is a computer implemented model of the organization that can provide a snapshot of a current or future state of the organization. Modeling an organization in this manner is advantageous and solves technology problems associated with organizing large corpus of data associated with an organization. The platform is able to integrate data not previously used in a computer model associated with a state of an organization.

Advancement in computational power and organization of data within a computing infrastructure enables modeling an organizational structure that runs in parallel in the background. The organizational model can be probed for inefficiencies to inform decision-makers of potential problems with their physical organizational structure and how adept the physical organizational structure is in meeting service level agreements. Building a model of this sort is involved, requiring interaction between different algorithms and requiring data compatibility between different logical functional blocks. Embodiments of the present disclosure provide advantages including visual probing of the developed model and visual display or snapshot of an organization or business unit at a certain slice in time.

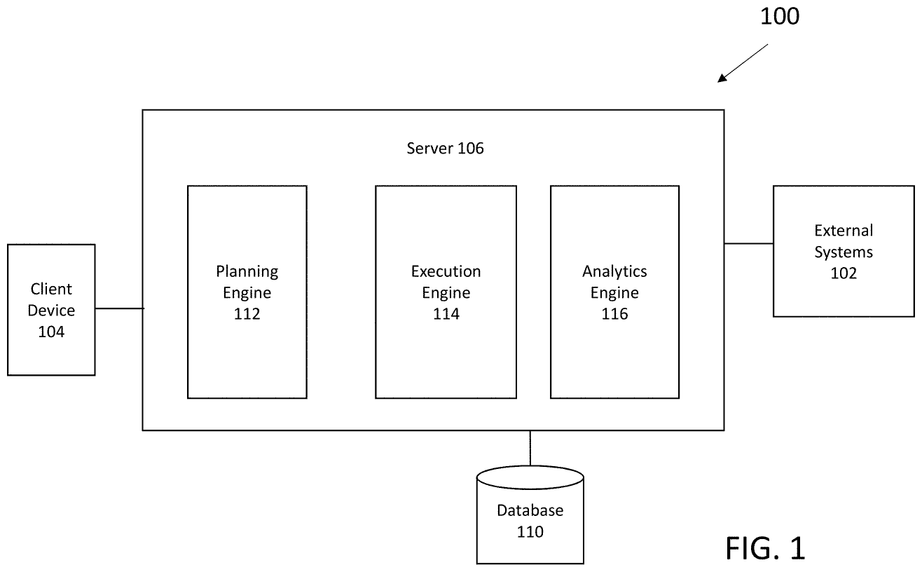

FIG. 1 illustrates a block diagram of a system 100 for modeling an organization, according to some implementations of the present disclosure. To simplify discussion, the singular form will be used for components identified in FIG. 1 when appropriate, but the use of the singular does not limit the discussion to only one of each such component. The system 100 includes a client device 104, an external system 102, a server 106, and a database 110. Each of these components can be realized by one or more computer devices and/or networked computer devices. The computer devices include at least one processor with at least one non-transitory computer readable medium.

The client device 104 is any device of a user (e.g., a support staff, a manager, or any other member within the organization). The client device 104 can be a laptop computer, a desktop computer, a smartphone, a smart speaker, etc. The client device 104 can request the server 106 create tickets. The client device 104 can request the server 106 create tickets using a chat interface with an artificial intelligence (AI) bot or facilitator running on the server 106.

The external system 102 represents any other systems that the server 106 interacts with. For example, when the AI bot facilitates in creating a ticket, robotic process automation scripts can be used to instruct the external system 102 to create the ticket. The external system 102 in this example is a ticket server. The server 106 can interact with multiple systems, as such, the creation of the ticket is merely used as an example for illustrative purposes. Email servers or messaging systems are other examples of the external system 102.

The system 100 can include the database 110 for information and parameter storage. For example, machine learning parameters can be stored in the database 110, algorithm parameters and settings can be stored in the database 110, user profiles can be stored in the database 110, team profiles can be stored in the database 110, intermediate calculations or data can also be stored in the database 110, etc.

The server 106 includes a planning engine 112, an execution engine 114, and an analytics engine 116. An engine is a combination of hardware and software configured to perform specific functionality. The planning engine 112 handles project planning activities which can include requirement analysis, backlog prioritization, work assignment to one or more teams, and/or capacity management. The execution engine 114 tracks project executions, project statuses, and/or percentage completion of projects. The analytics engine 116 provides descriptive analytics using data visualizations and reports.

In some embodiments, the planning engine 112 performs requirement analysis, work assignment, and forecasting. For example, software requirements include description of features and functionalities of a target software product. Software requirements convey expectations of users of the target software product. The software requirements can be obvious or hidden, known or unknown, or expected or unexpected from a user's point of view. In an example, software products that require internet connectivity may have a minimum security standard so that user data is protected. Users may not be aware of the minimum security standard, but software developers tasked with creating software products for internet connectivity will be aware of the minimum security standard and will have certain security features embedded as a requirement to realizing the software products.

The planning engine 112 receives work orders or work descriptions that include a technology domain, a client name, software requirements, or any combination thereof, from a user or a customer via the client device 104. Example software requirements can include a performance requirement, a specific use for the software, a specific feature, a network performance, a network connectivity, hardware support, milestones related to the software, one or more deadlines for reaching each of the milestones, etc. The planning engine 112 performs requirement analysis on the work description received from the client device 104. Requirement analysis involves analyzing the work description using text classification and machine learning techniques. Requirement analysis can also involve extracting and enumerating hidden requirements, for example, determining that “internet connectivity” in the work description implies a minimum security requirement (e.g., supporting transport layer security).

Requirement analysis relies upon previous knowledge. For example, a machine learning model can be trained to perform requirement analysis. Training set of data for requirement analysis includes previous requirements and associated teams that historically worked on the previous requirements. In some implementations, training can include placing requirements in an association table with one or more teams. For example, each of the requirements like “human-computer interaction”, “Bluetooth connectivity”, “LTE connectivity”, “blockchain”, etc., has one or more team associations. The planning engine 112 then inspects the received work description from the client device 104 to match each requirement in the work description with previous requirements. That is, the planning engine 112 performs a comparison to determine potential teams that can handle the work description. A decision tree can be used to perform the analysis, thus matching appropriate team(s) with the work description and providing a confidence number associated with each team matching.

In some implementations, all teams have a stored profile or project team data that includes team offers, clients, client connections, specializations, capacity, typical problems that the team solves, or any combination thereof. That is, the previous requirements can be stored in a team profile or in project team data such that the planning engine 112 can extract the previous information when performing the comparison with the received work description from the client device 104. The planning engine 112 matches an appropriate team to the received work description based on the comparison.

After requirement analysis, the planning engine 112 performs work assignment, which involves finding a best team to handle the software requirements identified during requirement analysis. Each team in the organization has an associated project team data which includes team offers, clients, client connections, specializations, capacity, typical problems that the team typically solves, or any combination thereof. The planning engine 112 can use the project team data and the software requirements to also perform forecasting. That is, the planning engine 112 can provide an estimate on when the selected best team will complete the software and/or each of the identified requirements. In some implementations, the planning engine 112 can rearrange priorities of one or more teams. For example, the planning engine 112 can use DevOps principles and a virtual facilitator for analyzing project team data and can prioritize work based on the analysis of the project team data.

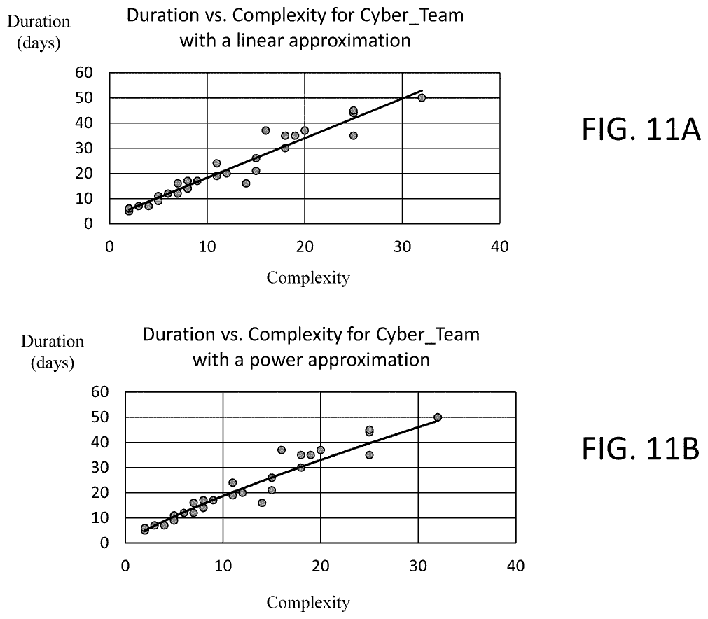

The planning engine 112 can provide a forecast on a service or work that a team is working on using linear regression. In an example, the linear regression can take as input a past team's performance on tasks of different complexities to develop a trend for estimating a forecast on how well the team will perform on a potential task. An example of linear regression is provided below in connection with FIGS. 11A and 11B.

In some implementations, the planning engine 112 can provide a forecast on a service or work that a team is working on using Monte-Carlo simulation. The Monte-Carlo simulation can involve varying an average time that the selected team usually completes a project by around a standard deviation, varying a number of individuals from the selected team that will be assigned to the work by around a standard deviation, varying a number of new projects that the selected team may be assigned by around a standard deviation to emulate the selected team being assigned additional future projects that can potentially impact the current work, etc. The different standard deviations can be based on previous data associated with the selected team's previous projects, completion times, frequency of work being assigned, etc. The Monte-Carlo simulation can involve increasing the standard deviations by several multiples.

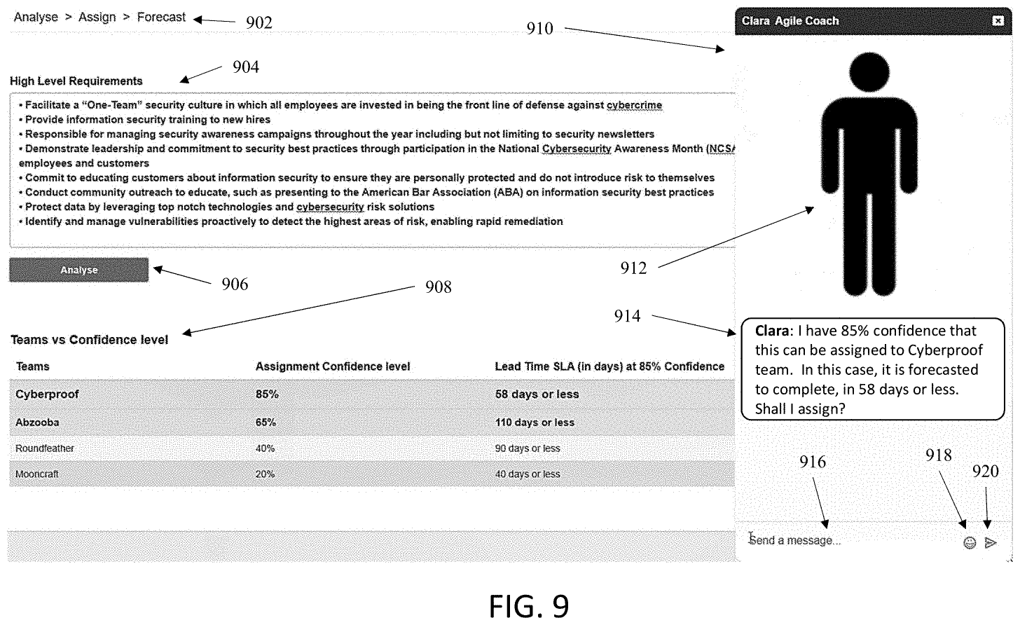

In some implementations, the planning engine 112 receives the work requirement from the client device 104 via a webpage. A user of the client device 104 can paste or upload the work requirement as a summary or a picture. The planning engine 112 can then analyze the work requirement to determine the team to handle the work requirement according to some implementations of the present disclosure. A confidence number can be associated with the team selected to implement the work requirement. Optical character recognition or text recognition can be used in deciphering text contained in images in order to determine the selected team. An example of providing feedback on team selection is provided below in connection with FIG. 9.

The execution engine 114 of the server 106 is configured to perform dependency management, estimate cost of delay, perform risk analysis, and perform risk mitigation. The execution engine 114 is an overseer of projects already underway and assigned. The execution engine 114 tracks execution of a project by monitoring completion of milestones, monitoring a percentage completion of the project, monitoring update status of the project (i.e., whether the project is blocked, active, etc.), and/or determining whether there are risks in project dependencies between project teams working on different aspects of the project, and providing support to mitigate risks identified.

The analytics engine 116 is configured to derive insights from team work data and/or provide health metrics based on the team work data. Health metrics can be provided in a dashboard view, which can include cycle time scatter plots, blocker cluster analysis, service demand and capacity workflow, work in-progress aging, etc. The analytics engine 116 provides descriptive analytics of each phase of one or more projects using data visualizations and reports viewable on the client device 104. In some implementations, a virtual assistant or a virtual coach can explain various statistics using burndown charts, velocity charts, flow efficiency etc. That is, instead of merely displaying charts and graphs on the client device 104, in some implementations, the analytics engine 116 explains the health metrics and derived insights aurally such that a user of the client device 104 can listen to the virtual assistant while viewing displayed charts and graphs.

Embodiments of the present disclosure will be described using examples. The examples are used merely for illustration purposes and are not meant to limit the present disclosure.

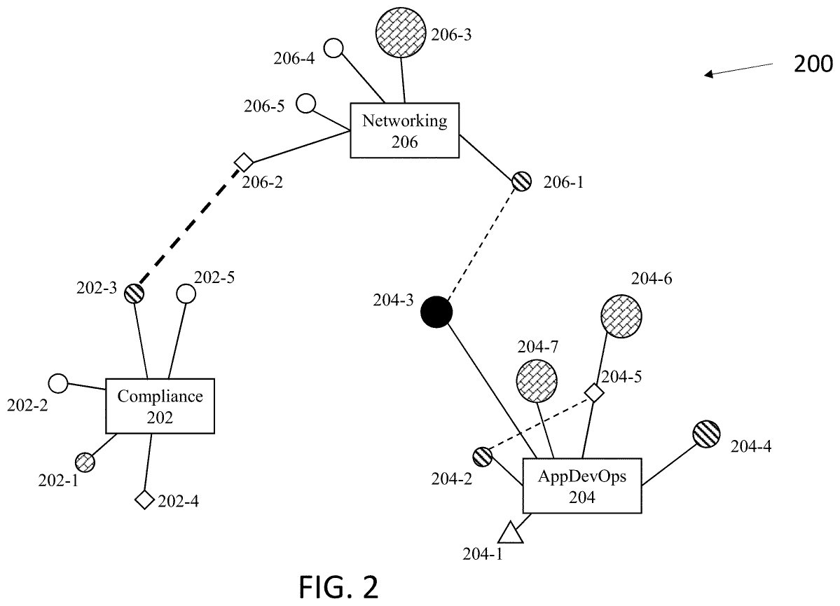

Given an organization that provides one or more services to external customers or internal customers within the organization, FIG. 2 illustrates a snapshot 200 of work items for various teams within the organization. The teams are Compliance 202, Networking 206, and AppDevOps 204. The work items for Compliance 202 include work item 202-1, 202-2, 202-3, 202-4, and 202-5. The work items for AppDevOps 204 include work item 204-1, 204-1, 204-3, 204-4, 204-5, 204-6, and 204-7. The work items for Networking 206 include work item 206-1, 206-2, 206-3, 206-4, and 206-5. These work items are merely provided as examples. A team may have any number of work items. A work item can represent a project, a sub-project, a task, a series of tasks, etc. The work item is generated based on work data which can include information from a myriad of sources (e.g., work orders, software requirements, information from project management tools, code commits from programmers, status reports from team members, etc.).

In some implementations, the snapshot 200 is displayed on the client device 104. The client device 104 can provide parameter settings on how the snapshot 200 is displayed. For example, the client device 104 can set a parameter to display only certain teams. That is, the client device 104 may hide a team from being displayed in the snapshot 200. In some implementations, the client device 104 is provided a menu by the server 106. The menu includes a multiple checkbox list with options including the set {“Networking”, “Compliance”, “AppDevOps”, “Security”, “Storage”, and “Other”}. The client device 104 can choose to display Networking, Compliane, and AppDevOps and choose to hide Security, Storage, and Other. In some implementations, the client device 104 can choose to also hide AppDevOps. If AppDevOps is hidden, then AppDevOps 204 and the work items 204-1, 204-2, 204-3, 204-4, 204-5, 204-6, and 204-7 will be hidden and not displayed in the snapshot 200.

The work items for the teams in the snapshot 200 can visually communicate some properties of work items. In some implementations, the work items can visually communicate a work item type via a shape associated with the work item. For example, under the team AppDevOps 204, the work items 204-1, 204-2, and 204-5 have different shapes. The work item 204-1 is a triangle, the work item 204-2 is a circle, and the work item 204-5 is a diamond. Other shapes can be envisioned, for example, any polygon, a crescent shape, a half circle, a star, etc. Circle, triangle, and diamond are merely provided as examples in FIG. 2. Work item type can be team-dependent, business-dependent, or industry-dependent. For example, to illustrate team-dependency, a circle in the AppDevOps 204 team can represent an initiative, a triangle can represent an application feature, a square can represent a support request, etc. While in the Compliance 202 team, a circle can represent a case identification, a square can represent a request for proposal (RFP), a triangle can represent a service request, etc.

In some implementations, work types are department dependent instead of team dependent. For example, Networking 206 and AppDevOps 204 can share similar work types since both can be classified as being technology-related and thus, under the same department. Compliance 202, on the other hand, can have a separate set of work types.

In some implementations, work types are universal for an organization (i.e., an organization providing services in only one industry). A circle can indicate a project and/or feature, a diamond can indicate strategic initiatives, and a triangle can indicate risks.

Another property that can be visually communicated in the snapshot 200 is a cost of delay associated with the work item. The cost of delay can be communicated by a size or an area consumed by the shape of the work item. For example, in the snapshot 200, the work items 204-7 and 204-6 have a larger size than the work item 204-3, which has a larger size than the work item 204-2. At a glance, the relative sizes between the different work items readily communicate a cost of delay associated with each of the work items. A larger-sized work item can indicate a greater cost of delay compared to a smaller-sized work item.

In some implementations, the client device 104 can set parameters to hide work items of certain sizes. For example, the client device 104 can set parameters to hide work items that have a cost of delay under $15,000 per week. In some implementations, the client device 104 is provided a list with multiple options and the client device 104 can select various choices to display, for example, $5,000 per week, $10,000 per week, $15,000 per week, $30,000 per week, $50,000 per week, $70,000 per week, $100,000 per week, etc. Although cost of delay is quoted in dollars per week in the example, cost of delay can be quoted in other units that indicate a finite cost per unit time.

The cost of delay communicates an impact of time on a work item's expected outcomes. For example, the work item 204-1 may have been budgeted to cost $40,000 if completed within 5 weeks. If the work item 204-1 gets delayed by a week, the cost of delay will indicate $2000, bringing the total cost of the work item 204-1 to $42,000 if completed in 6 weeks. In some implementations, if the work item 204-1 gets completed early, for example, in 4 weeks, then the cost of delay indicates that $2,000 was saved. Hence the total cost of the work item 204-1 is reduced to $38,000 for being completed in 4 weeks.

Each work item can have a work item status. The work item status may or may not be communicated visually. The work item status depends upon how the work item is processed and can vary accordingly. Example values for the work item status include percentage of completion of completion of the work item (e.g., 20%, 25%, 50%, 70%, 100%, etc.).

In some implementations, the cost of delay profile can be visually communicated based on a fill (or color) of the shape associated with the work item. For example, the work items 204-3, 204-7, 204-1, and 204-4 have different fills indicating different cost of delay profiles. Examples of cost of delay profiles include “Increase Revenue”, “Protect Revenue”, “Reduce Cost”, and “Avoid Cost”. Visual indication of cost of delay profile readily communicates to the user of the client device 104 how costs or cost overruns associated with a work item should be handled. Similar to other properties, the client device 104 can elect to see only selected cost of delay profiles. For example, if the work item 204-3 being filled solid (as in FIG. 2) indicates an “Avoid Cost” profile, and the client device 104 indicates that “Avoid Cost” profiles should not be shown in the snapshot 200, then the work item 204-3 will fail to appear on the snapshot 200. Any lines linking to the work item 204-3 will also fail to appear in the snapshot 200.

In some implementations, a fill color is reserved for indicating whether a work item is blocked (or stopped) due to some issues. For example, the fill color red can indicate that a work item is blocked. In another example, a solid fill can indicate that the work item is blocked.

In some implementations, another property is a class of service associated with a work item. The class of service refers to a policy that defines how the work item types are served or treated for a specific service in an organization. That is, not all work item types are handled in a same way. Some types of work items may need special or urgent treatment compared to other types of work items. In some implementations, there are four classes of service used in information technology (IT) service delivery organizations. These include “expedite”, “fixed date”, “standard”, and “intangible”. Work items designated as “expedite” are work items which need to be handled immediately to avoid revenue loss. Work items designated as “fixed date” are work items associated with legal and/or security compliance or work items with date-driven timelines. Work items designated as “standard” are regular work items that need to be prioritized and completed. Work items designated as “intangible” are work items that are not associated with immediate revenue loss, however, long delays may incur revenue loss and may force the work item into a higher class of services. Examples of services classified as intangible include proof of concept, upgrades, research, etc.

In some implementations, another property associated with work items is a risk associated with a work item. The risk can be visually communicated on the snapshot 200 via animations. Risk can be a Boolean value which takes on two values “not risky” and “risky”. Items that are not risky can be static on the screen of the client device 104, while items that are risky can be shown as blinking or flashing on the screen.

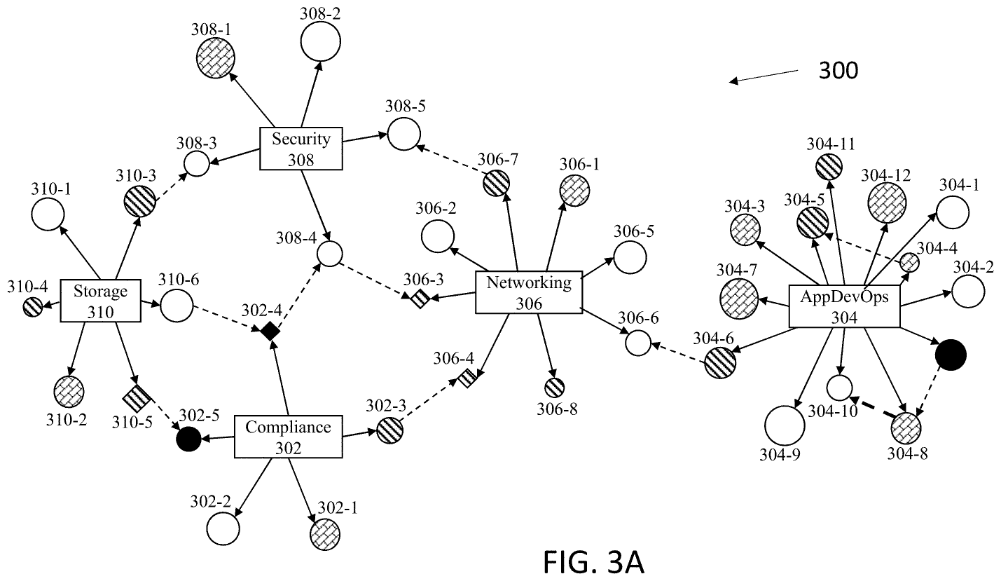

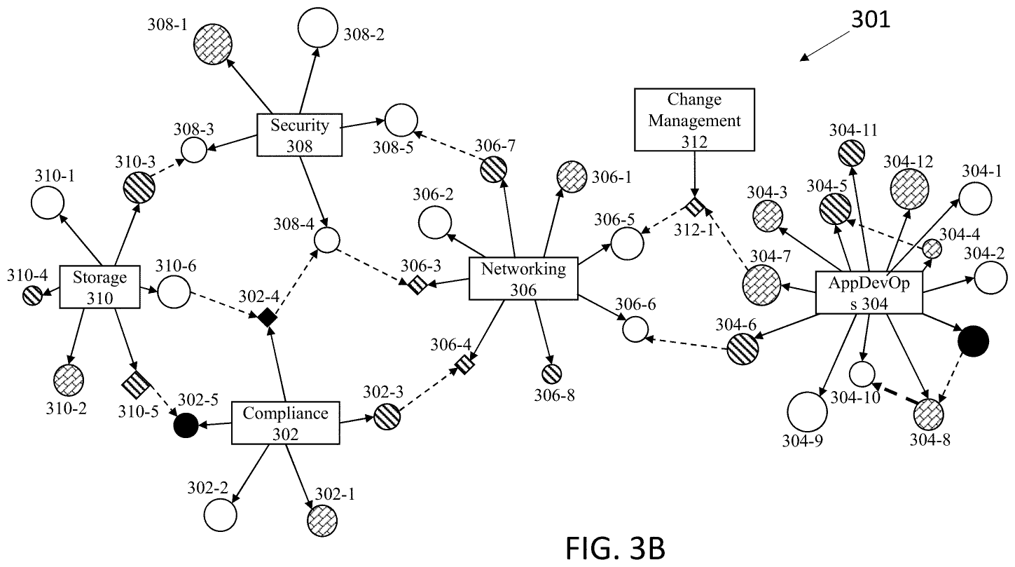

In some implementations, dependencies between two work items are visually communicated to the user of the client device 104 via lines. Dependencies are shown as dashed lines in FIG. 2. For example, there is a dependency between the work items 202-3 and 206-2. There is also a dependency between 204-3 and 206-1. There is another dependency shown between 204-2 and 204-5. A weight or thickness of the lines can indicate how strongly two work items are dependent. For example, the line between the work items 202-3 and 206-2 is thicker than the line between the work items 204-3 and 206-1, which indicates that there is a stronger dependency between the work items 202-3 and 206-2 compared to 204-3 and 206-1. In some implementations, the lines can be directed to show, between a first work item and a second work item, which whether the first work item is dependent on the second or vice versa, or whether the first work item is more dependent on the second work item than the second work item is dependent on the first work item (see e.g., FIGS. 3A and 3B).

A work item can be stored in the database 110 as in a data class that allows quickly displaying snapshots, e.g., the snapshot 200. In some implementations, the data class for a work item includes properties such as a work identification (ID), a team ID, a cost of delay, a dependence, a risk, a class of service, a blocked status of the work item, a cost of delay profile, a work status of the work profile, or any combination thereof. One of more of these properties can be stored as a static value or stored as a pointer in the database 110. Storing some work item properties as pointers allows the server 106 to partition analysis and determining values of properties such that when a property is updated, the work item points to a most recent value of the property. That way, any analysis being performed on a work item is being performed using real-time data rather than static data that needs to be updated. Having a data class for work items allows a level of organization of the database 110 to facilitate real-time processing of information and eliminate data duplication that can introduce errors when older values are not updated.

FIG. 3A illustrates a snapshot 300 of work items according to an embodiment of the present disclosure. The snapshot 300 includes 5 teams, which are Compliance 302, AppDevOps 304, Networking 306, Security 308, and Storage 310. Each of these teams have work items. For example, the Compliance 302 team includes work items 302-1, 302-2, 302-3, 302-4, and 302-5. The AppDevOps 304 team includes work items 304-1, 304-2, 304-3, 304-4, 304-5, 304-6, 304-7, 304-8, 304-9, and 304-10, 304-11, and 304-12. The Networking 306 team includes work items 306-1, 306-2, 306-3, 306-4, 306-5, 306-6, 306-7, and 306-8. The Security 308 team includes work items 308-1, 308-2, 308-3, 308-4, and 308-5. The Storage 310 team includes work items 310-1, 310-2, 310-3, 310-4, 310-5, and 310-6. The dependencies between different work items is also indicated in FIG. 3A as dashed lines.

The snapshot 300 can be interactive, allowing the user of the client device 104 to probe dependencies and relationships. For example, in FIG. 3A, the dependency between work items 306-6 and 304-6 can be probed. Take a case where the work item 306-6 is waiting for the work item 304-6 to be completed. The server 106 can determine that based on a current risk assessment that the work item 304-6 runs a risk of not meeting a service level agreement (SLA), thus causing a delay cascade that further delays a completion date of the work item 306-6. The server 106 can determine based on the risk assessment that an action should be taken to mitigate the risk posed by a delay cascade.

In some implementations, as the AppDevOps 304 team is working on the work item 304-7, a realization of a new dependency arises between the work item 304-7 and the work item 306-5 of the Networking 306 team. The client device 104 can instruct the server 106 to create a dependency between the work item 304-7 and 306-5 since none exists. Once the dependency is created, the server 106 can perform a risk analysis to determine an effect of the created dependency on both of the work items 304-7 and 306-5. In some implementations, effect of the created dependency on all work items in FIG. 3A is performed. The server 106 can then provide recommended actions on how to mitigate risk once one or both of the work items 304-7 and 306-5 are deemed to be at high risk. For example, the work item 304-7 can be determined to be at high risk, and hence, the server 106 recommends that a change in management be performed such that the SLA for the work item 304-7 can be met. The server 106 can prompt the client device 104 asking whether to generate a support ticket for changing management.

The client device 104 can accept the recommendation from the server 106 for change in management, and the server 104 can automatically generate the support ticket. FIG. 3B illustrates a resulting snapshot 301 once the support ticket is generated. As shown in FIG. 3B, a work item 312-1 indicates work to be performed by a team Change Management 312 in order to mitigate the risk identified in the newly discovered dependency between the work item 304-7 and 306-5.

Risk prediction can be determined by the server 106 using five attributes. Risk prediction can be reported on an individual work item basis. For example, when predicting risk due to the newly discovered dependency between the work item 304-7 and 306-5, the server can provide results indicating that a specific work item is risky or not risky (i.e., at high risk or at low or no risk). In some implementations, more than two levels of risk can be used (e.g., no risk, low risk, medium risk, high risk). Five attributes of a work item can be used in risk assessment. A first of these attributes is a cost of delay for a work item being assessed. A second of these attributes is a number of dependencies present for the work item being assessed. A third of these attributes is a current status of the work item being assessed. In some implementations, the current status of the work item can be expressed as “Active” or “Blocked”. In some implementations, the current status of the work item can also be expressed as “In Progress”, “Waiting”, “Blocked”, “Completed”, etc. A fourth of these attributes is a remaining percentage till completion of the work item. A fifth of these attributes is a number of days that the work item has been blocked. Work items can be blocked for one or more of the following reasons: (a) external team involvement (i.e., dependency with an external team), (b) resource unavailability, (c) pending clarifications in requirement, etc.

These attributes can be used in a K-nearest neighbors (KNN) algorithm for risk prediction. From a visual snapshot (e.g., the snapshot 300), a user of the client device 104 can drag a line to connect two different work items in order to add a dependency between the two different work items. Once the connection is established between the two different work items, the execution engine 114 of the server 106 performs risk analysis based on the change in the snapshot, and updates the risk. The model represented as the snapshot is executed across all work items based on attributes associated with each work item. For example, the five attributes (cost of delay, number of dependencies, current status, remaining percentage until completion, and number of days blocked) are used in the KNN algorithm to determine and update risk whenever a change is made to the snapshot. The model developed via KNN algorithm can use only the five attributes such that training data is developed from historical data prepared from various sources including project management tools such as JIRA, spreadsheets, etc. Risk levels can be assigned based on clusters discovered via the KNN algorithm. For example, a label can be provided for certain clusters as being low risk or high risk. That way, whenever a work item ends up in any of those classified clusters, the execution engine 114 is able to place the label of low risk or high risk on the work item.

The five attributes identified above for risk prediction are a surprising result because factors or features that the inventors envisioned would be strong indicators of risk were not as significant as the five attributes. For example, a number vacations of team members for a work item or a number of team members on vacation were not strongly correlated with risk. Furthermore, productivity measures of the team were found to not be strongly correlated with risk as well.

The system 100 can be used to generate a model of activities, services, and work being performed within an organization. The system 100 can also be used to visualize certain aspects of the model as described in connection with the snapshots 200, 300, and 301 of FIGS. 2, 3A, and 3B. Visualizing the organizational model allows the user of the client device 104 to have a holistic view of services, information flow, and work being performed in the organization. Furthermore, the client device 104 can interact with the services (or work items) to experiment with changes within the model. The server 106 is configured to calculate risk associated with any changes of the model proposed via the interaction. The risk assessment performed by the server 106 provides immediate feedback on whether a certain change may be catastrophic to realizing one or more goals of the organization. Embodiments of the present disclosure thus provide a holistic view of knowledge work and/or general work performed within the organization, and therefore, a virtual model of the organization that can be probed before making any changes in the real-world.

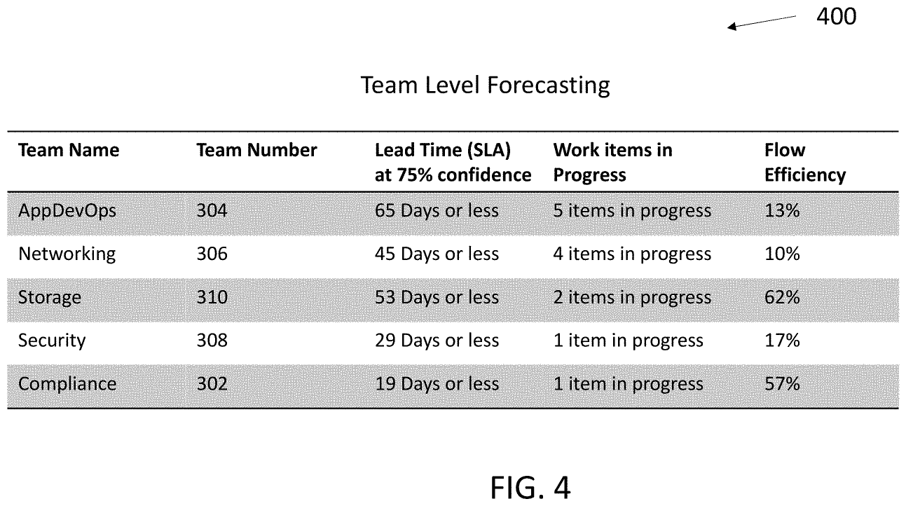

FIG. 4 illustrates a table 400 showing example results of a Monte-Carlo analysis on work items according to some implementations of the present disclosure. Monte-Carlo analysis can be used to provide team level forecasting as provided in the table 400. Team identification information can be provided as team name and team number. Monte-Carlo analysis can yield lead time with a specific level of confidence. In the example provided, a 75% confidence is listed. In some implementations, a 50%, 70% 80%, 90%, 95%, or any other percentage confidence is used. Number of work items in progress can also be listed in the results. Flow efficiency can also be calculated. Flow efficiency depicts an efficiency associated with a work item within a workflow, that is, flow efficiency can provide an actual time a team spends on a work item. Flow efficiency can thus be calculated based on actual work time measured against total wait time. A higher percentage of flow efficiency, the better and smoother a process of turning a work order or work description into a workable feature. One interpretation of the first line item in the table 400 is: “With 75% confidence, the AppDevOps 304 team with 5 work items in progress can complete these 5 work items within 65 days.” Flow efficiency can be calculated as work time divided by the sum of work time and wait time. Work time can be defined as time spent by a work item in an “In Progress” status. Wait time can be defined as time spent by the work item in a “Blocked” and “Waiting” status, that is, total time that the specific work item was not being actively worked on.

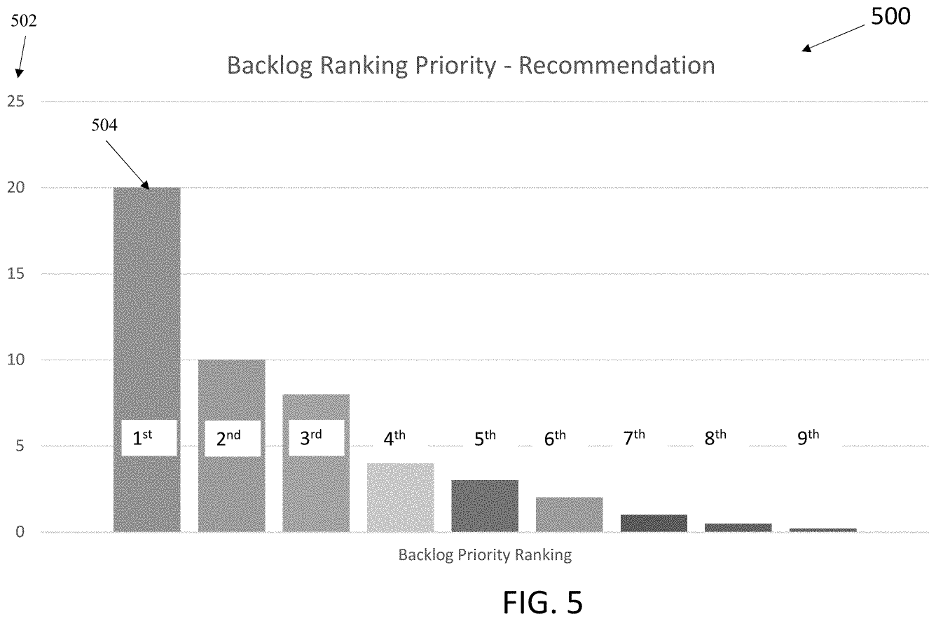

FIG. 5 illustrates a ranking graph 500 according to some implementations of the present disclosure. The ranking graph 500 is developed by the server 106 based on a weighted shortest job first algorithm applied to a cost of delay. A priority is given to each backlogged work item so that the user of the client device 104 can readily identify which work items should be tackled first. The weighted shortest job first algorithm balances the cost of delay with how quickly a work item can be completed. The X-axis of the ranking graph 500 displays the backlog priority ranking with values expressed as ordinal numbers—first, second, third, fourth, fifth, sixth, seventh, eighth, ninth, etc. Each bar (e.g., the bar 504) in the ranking graph 500 represents a work item. The height of the bar is dictated by the Y-axis which represents cost of delay 502. The bar 504 has a cost of delay of 20 units/unit time (e.g., $20,000/week). The server 106 can generate the ranking graph 500 for display on the client device 104 to communicate an order for tackling a backlog. In some implementations, hovering over a bar in the ranking graph 500 provides additional information about the specific work item.

In some implementations, linear regression is used in determining priority for backlogged work items. For example, complexity and cost of delay for historical projects or work items can be inputs to the linear regression model. From the linear regression model, priorities can be determined.

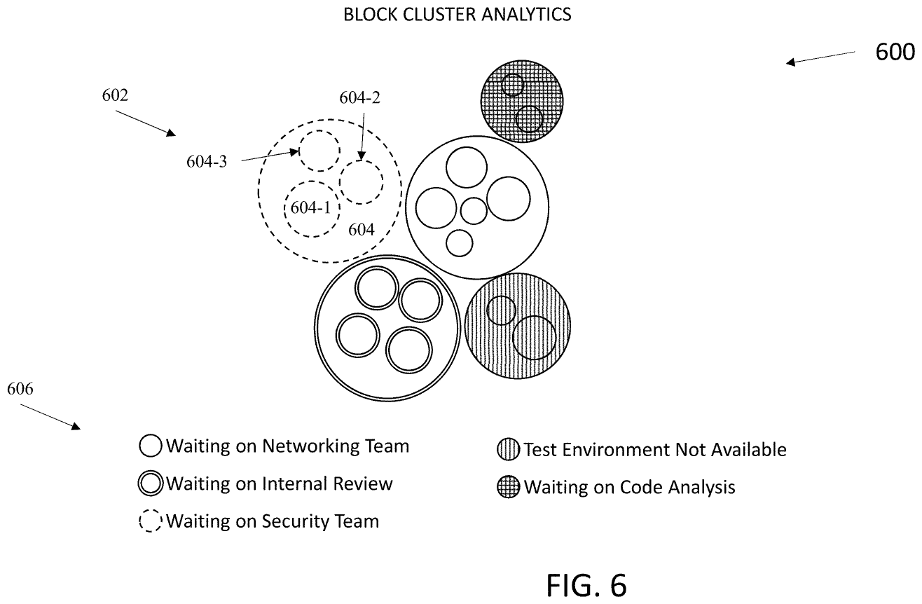

FIG. 6 illustrates a block cluster interface 600 for insight analysis generated by the server 106 according to some implementations of the present disclosure. The block cluster interface 600 can group work items in bins different from the team groupings (e.g., as shown in connection with FIG. 3A). The block cluster interface 600 includes a graphical depiction 602 and a legend 606 describing the graphical depiction 602. The graphical depiction 602 can include multiple clusters (e.g., a cluster 604) with one or more work items (e.g., the work items 604-1, 604-2, and 604-3).

The legend 606 provides the user of the client device 104 access to meanings of the clusters in the graphical depiction 602. Certain work items can be on hold waiting on dependencies from other teams. The block cluster interface 600 can indicate which work items are in a wait mode. In some implementations, the clusters for waiting are separated by specific teams as shown in FIG. 6 where there is a cluster for work items waiting on the networking team and a cluster for work items waiting on the security team.

Furthermore, clusters need not be specified merely for team level analysis. Clusters can provide a current status of a work item. For example, in an IT environment, work items can be on hold because a test environment is not yet available. A work item can also be on hold due to waiting on code analysis. A work item can also be on hold due to waiting on internal review. FIG. 6 includes these clusters as well as clusters that indicate team level analysis. FIG. 6 provides examples of clusters for insight analysis, but other clusters may be envisioned or extracted and grouped by the server 106.

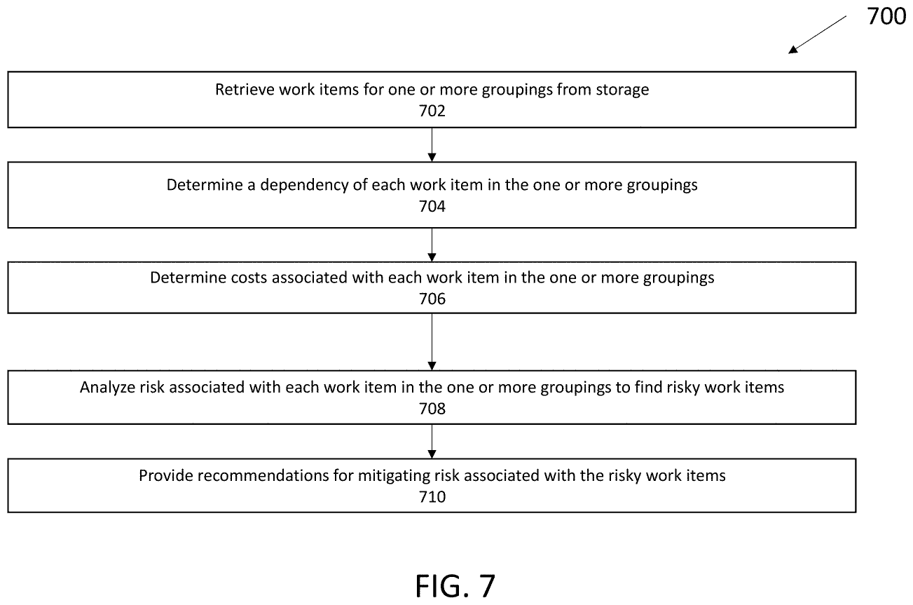

FIG. 7 is a flow diagram illustrating a process 700 for displaying several metrics according to some implementations of the present disclosure. The process 700 can be performed by the server 106. At step 702, the server retrieves work items for one or more groupings from storage. The groupings can be team groupings as discussed in connection with FIG. 3A.

At step 704, the server 106 determines a dependency for each work item in the one or more groupings.

At step 706, the server 106 determines costs associated with each work item in the one or more groupings. In some implementations, the costs are included in the data structure for the work items retrieved at step 702.

At step 708, the server 106 analyzes risk associated with each work item in the one or more groupings to find risky work items. In some implementations, risk analysis is performed in response to a change in dependency. For example, the client device 104 can indicate a formation of a new dependency, and the server 106 can then determine how risky the new dependency is.

At step 710, the server 106 provides recommendations for mitigating risk associated with the risky work items. In an implementation, a recommendation includes change of management.

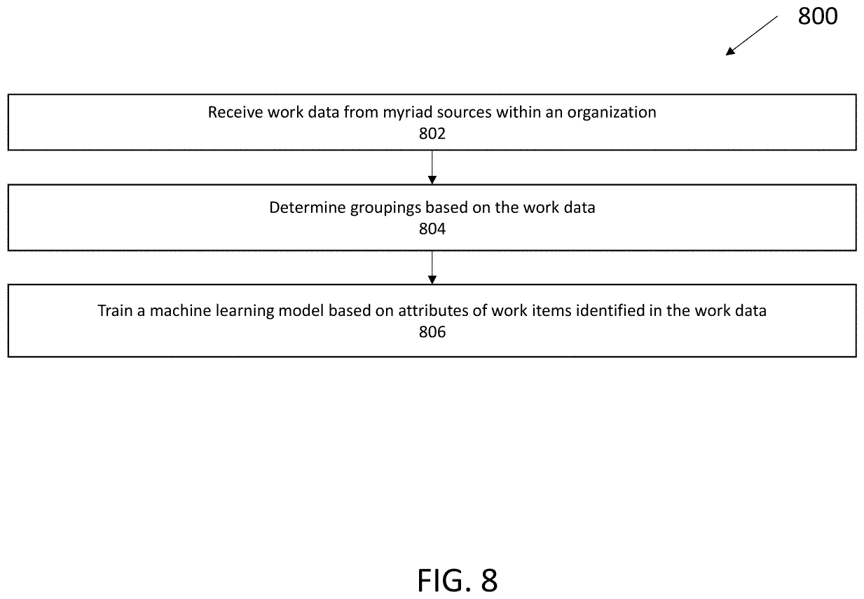

FIG. 8 is a flow diagram illustrating a process 800 for generating a computer model of an organization according to some implementations of the present disclosure. The process 800 is performed by the server 106. At step 802, the server 106 receives work data from myriad sources within the organization. The work data includes historical data for work items prepared from project management tools, spread sheets, etc., as previously discussed in connection with FIG. 3B. The work data can include five attributes (cost of delay, number of dependencies, current status, remaining percentage until completion, and number of days blocked) for each identified work item within the work data.

At step 804, the server 106 determines groupings based on the work data. In some implementations, the groupings are department-based. For example, IT department, business department, etc. In some implementations, the groupings are team-based. For example, application development team, networking team, security team, etc. The work data includes identifiers that can be used to determine the groupings.

At step 806, the server 106 trains a machine learning model based on attributes of work items identified in the work data. The attributes can be the five attributes included at step 802 in the work data. Each work item used in training the machine learning model has a risk score assigned to it once mapped in a feature space. For example, as described in connection with FIG. 3B above, the feature space can be divided into risky clusters and non-risky clusters such that each work item falling into part of the feature space where risky clusters are present is tagged as being risky, while each work item falling into part of the feature space where non-risky clusters are present is tagged as being non-risky. Although described as an example in terms of risky and non-risky, different levels of risk can be used in other embodiments. For example, five levels of risk can be used where the feature space is divided into five different levels so that more nuanced levels of risk like medium risk or medium-high risk and so on can be defined.

Embodiments of the present disclosure provide several advantages. Some implementations of the present disclosure can be applied in an information technology (IT) context. An IT organization provides services to customers. An IT organization can be tasked with developing applications, troubleshooting hardware and software issues, maintaining security systems, upgrading and/or updating computing infrastructure, etc. An IT organization may not only have IT technical experts but business and support staff as well. The different individuals may be split into multiple teams and organized in different hierarchies within the IT organization. Embodiments of the present disclosure can help an organization, like the IT organization, provide transparency on how work between the different teams relate to each other. This can enhance alignment of goals within the IT organization and can improve predictability across all the different teams. For example, if one IT team is dependent on work item from a business team, then embodiments of the present disclosure can be used to provide the IT team information on risk and expected delivery of the work item from the business team.

Embodiments of the present disclosure continually learn and share insights with recommendations. For example, during requirement analysis, the planning engine 112 can receive requirements and process the requirements using natural language processing. The team selected by the planning engine 112 based on the requirement analysis is an example of a recommendation. The team selected by the planning engine 112 can be provided along with a confidence value (e.g., the confidence value can be quoted in percentage). The confidence value can be associated with a forecast for when the selected team can complete the work item. Machine learning can be used to determine recommendations associated with team selection. For example, certain requirements can be associated with one or more teams in a set of teams so that when the planning engine 112 performs natural language processing, teams with a maximum number of matched terms are selected as the teams to tackle the work item.

In another example, the execution engine 114 can perform risk analysis and provide a risk recommendation of no risk or high risk. Risk categories (e.g., no risk, low risk, medium risk, high risk, etc.) can be included in the training data, e.g., when training the model according to FIG. 8. In another example, based on a type of risk involved, the execution engine 114 can suggest various risk mitigation plans. The risk mitigation plans can be part of the training data as well and can include actions, such as changing management, sending an email or providing a text message or a voice message to an administrative team, scheduling or performing follow-up with the team, etc.

Embodiments of the present disclosure allow teams to plan work and prioritize work based on information provided by the system. Embodiments of the present disclosure can be provided for different industries including IT, human resources, immigration, finance, sales, support departments, etc. Some implementations of the present disclosure can be provided for unbiased work prioritization using weighted shortest job first. Schedule of deliverables on services or work items can be analyzed using Monte-Carlo analysis. Machine learning can be applied for risk prediction. Proactive risk mitigation can be accomplished via robotic process automation. Robotic process automation can be used to automate manually repetitive project management tasks. A user interface that includes a virtual process improvement coach and facilitator can aid users in using the system for risk analysis and risk prediction.

Embodiments of the present disclosure can integrate with other products such as codebase, test, and continuous integration and continuous delivery (CI/CD) to provide an end-to-end service and product delivery platform. A holistic view and transparency of end-to-end service deliverables with different user profiles (as depicted in FIGS. 3A and 3B) can be provided. Cost of delay and class of services can be used for insight analysis. A user has an ability to filter and visualize a work item based on impact of the cost of delay, the class of service. The system can perform continuous forecasting of the system using linear regression and/or Monte-Carlo simulation and machine learning to derive unbiased work prioritization. The system can realize requirement analysis and work assignments using machine learning.

Embodiments of the present disclosure provide performance metrics for an organization, allow work prioritization, and allow backlog item prioritization based on collected data. Such a holistic view is not present in conventional systems. Embodiments of the present disclosure provide the ability to experiment and probe generated or developed models to determine how agile or elastic an organization is without the need to perform social experiments. The following discussion provides examples according to some implementations of the present disclosure.

FIG. 9 illustrates a screenshot of a website showing an example of requirement analysis according to some implementations of the present disclosure. The website can have a navigation menu 902. The navigation menu can indicate that a user viewing the website (e.g., a user of the client device 104) is on “Forecast” section of the webpage. On the “Forecast” section of the webpage, there can be a textbox 904 for the user to input requirements. Input requirements (i.e., high level requirements) can be copied and pasted or typed into the textbox 904. In some implementations, the “Forecast” section allows image uploads as discussed above in connection with FIG. 1. After the input requirements are entered, a button 906 on the webpage labeled “Analyse” can be pressed by the user, thus submitting the input requirements for requirement analysis by the server 106.

The server 106 can then return results 908 as provided in FIG. 9. The results can include a list of teams, and for each team, a confidence level for the team selected and a lead time SLA with a certain percentage confidence. For example, in FIG. 9, “Cyberproof” team is assigned with an 85% confidence level in the assignment and is expected to complete the task in 58 days or less with an 85% confidence in the lead time. “Mooncraft” team, on the other hand, is assigned with a 20% confidence level in the assignment and is expected to complete the task in 40 days or less with an 85% confidence level in the lead time.

The webpage can not only provide a table of the results 908, but in some implementations, can support popup messaging where a popup messaging window 910 appears. A facilitator AI can interact with the user via the popup messaging window 910. In FIG. 9, the facilitator AI can have a likeness 912. The likeness 912 can be animated such that a mouth of the likeness 912 moves when speech of the facilitator AI is read by a processor in the client device 104. In some implementations, the likeness 912 is a static photograph. In addition to the likeness 912 mimicking speech provided by a speaker of the client device 104, text 914 associated with the speech can be displayed in the popup messaging window 910. The text 914 can be “I have 85% confidence that this can be assigned to Cyberproof team. In this case, it is forecasted to complete, in 58 days or less. Shall I assign?” A textbox 916 is provided in the popup messaging window 910 for the user to respond to the facilitator AI. The user can use symbols under the item 918 to respond or can type text into the textbox 916 and press the arrow 920 to submit the typed text.

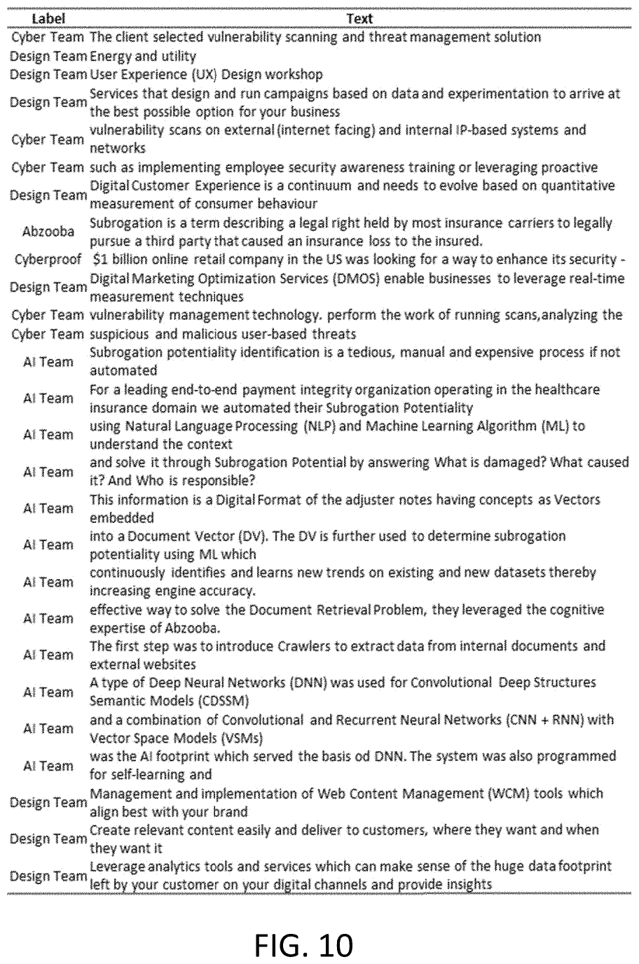

FIG. 10 provides an example training set for requirement analysis according to some implementations of the present disclosure. The example training set includes a label which identifies the team, and text which identifies requirements. As such, after training a decision tree with the example training set in FIG. 10, the decision tree (as discussed above in connection with FIG. 1) can be used to determine which team best satisfies a given requirement. Each node in the decision tree has associated probabilities or confidences, thus traversing each node to arrive at leaf nodes which include teams to select from will accumulate a certain confidence level. From the text analysis, the team can thus be selected with a confidence level associated with the decision tree.

FIGS. 11A and 11B provide example duration graphs used for duration approximation according to some implementations of the present disclosure. FIG. 11A uses a linear approximate trendline to fit data points while FIG. 11B uses a power approximate trendline to fit data points. FIGS. 11A and 11B visually depict an example of what linear regression accomplishes based on disparate historical data inputs collected over time. For example, when trying to determine how long a certain team will complete a new task by, a complexity of the new task is estimated. The complexity can be provided by the user or can be determined by the server 106 based on machine learning tools in light of previous work items with similar requirements. Linear approximation involves determining a hypothesis and then minimizing an error associated with the hypothesis. In FIG. 11A, the hypothesis is a line, and after looking at historical projects of the “Cyber_Team” team, an equation for the line can be obtained and used to estimate duration of days for any complexity. In FIG. 11B, the hypothesis is a power function, and similarly, linear regression is used to determine an equation for the power function, thus allowing the power function to be used in estimating duration of days for any complexity. Line and power function are merely used as examples and other hypotheses functions like polynomial, cubic, square root, etc., can be used to fit any data. Furthermore, complexity and duration are used merely for illustrative purposes. Linear regression can be applied to higher dimensions so that other factors that affect duration can be taken into account if necessary. For example, a number of individuals in the team can be taken into account.

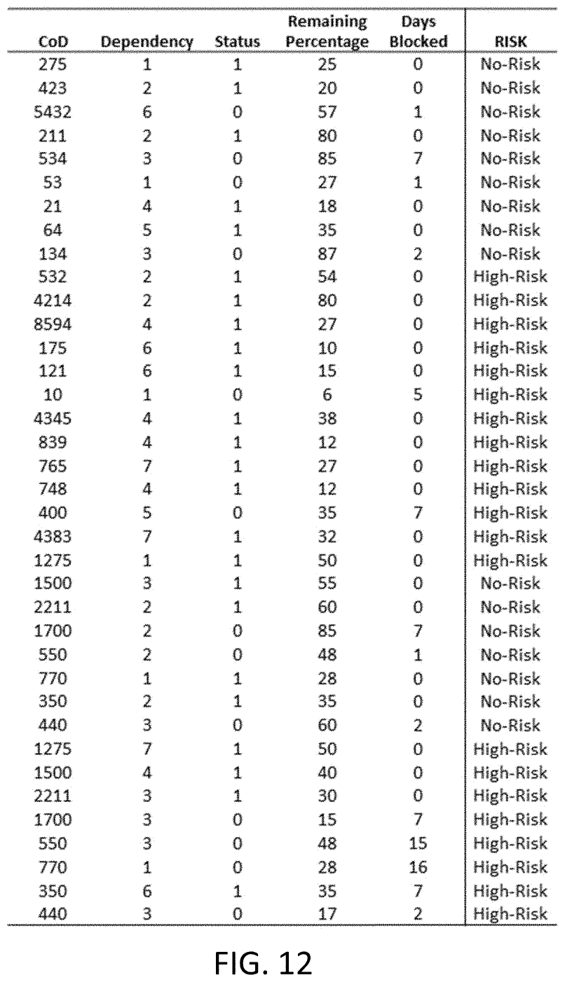

FIG. 12 provides sample training data for “risk” or “no-risk” classification using KNN algorithm. The five attributes—cost of delay, number of dependencies, current status, percentage till completion, and number of days blocked—are used in assessing risk. The KNN algorithm is used on the sample data and resulting in a number of clusters. The clusters can be labeled as “risk” or “no-risk” based on the sample training data provided in FIG. 12. With the labeling, the KNN algorithm is able to draw boundaries between different clusters in the feature space so that a new combination of the five attributes plotted in the feature space will land within a “risk” or “no-risk” category. FIG. 12 is merely used as an example and more than two categories of risk can be defined, as discussed above in connection with FIG. 3B.

According to some embodiments of the present disclosure, processes described above with reference to flow charts or flow diagrams (e.g., in FIGS. 7-8) may be implemented in a computer software program. For example, some embodiments of the present disclosure include a computer program product, which includes a computer program that is carried in a computer readable medium. The computer program includes program codes for executing the process 700 and/or the process 800. The computer program may be downloaded and installed from a network (e.g., the Internet, a local network, etc.) and/or may be installed from a removable medium (e.g., a removable hard drive, a flash drive, an external drive, etc.). The computer program, when executed by a central processing unit implements the above functions defined by methods and flow diagrams provided herein in the present disclosure.

A computer readable medium according to the present disclosure may be a computer readable signal medium or a computer readable storage medium or any combination of the above two. Examples of the computer readable storage medium may include electric, magnetic, optical, electromagnetic, infrared, or semiconductor systems, elements, apparatuses, or a combination of any of the above. More specific examples of the computer readable storage medium include a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above.

The computer readable storage medium according to some embodiments may be any tangible medium containing or storing programs, which may be used by, or used in combination with, a command execution system, apparatus or element. In some embodiments of the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

A computer program code for executing operations in the present disclosure may be compiled using one or more programming languages or combinations thereof. The programming languages include object-oriented programming languages, such as Java or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or electronic device. In the circumstance involving a remote computer, the remote computer may be connected to a user's computer through any network, including local area network (LAN) or wide area network (WAN), or be connected to an external computer (for example, connected through the Internet using an Internet service provider).

The flow charts and block diagrams in the accompanying drawings illustrate architectures, functions and operations that may be implemented according to the systems, methods and computer program products of the various embodiments of the present disclosure. Each of the blocks in the flow charts or block diagrams may represent a program segment or code that includes one or more executable instructions for implementing specified logical functions. It should be further noted that, in some alternative implementations, the functions denoted by the flow charts and block diagrams may also occur in a sequence different from the sequences shown in the figures. For example, any two blocks presented in succession may be executed substantially in parallel, or sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

Engines, handlers, generators, managers, or any other software block or hybrid hardware-software block identified in some embodiments of the present disclosure may be implemented by software, or may be implemented by hardware. The described blocks may also be provided in a processor, for example, described as: a processor including a planning engine, an execution engine, an analytics engine, etc.

While the present disclosure has been described with reference to one or more particular implementations, those skilled in the art will recognize that many changes may be made thereto without departing from the spirit and scope of the present disclosure. Each of these embodiments and implementations and obvious variations thereof is contemplated as falling within the spirit and scope of the present disclosure, which is set forth in the claims that follow.

What is claimed is:

1. A system for displaying an organization model, the system including a non-transitory computer-readable medium storing computer-executable instructions thereon such that when the instructions are executed, the system is configured to:
retrieve work items from storage, each work item including at least one requirement;
determine, for each of the work items, one or more dependencies;
determine a relative ranking of costs for the work items; and
provide, to a client device, visualization parameters for representing the work items,
wherein for a respective work item, the visualization parameters include a first visual indicator representing a type of work item, a second visual indicator representing a cost of delay associated with the work item, and a third visual indicator representing a cost of delay profile for the work item, and
wherein the visualization parameters further include a fourth visual indicator for linking pairs of work items to indicate a dependency between the linked work items.

2. The system of claim 1, wherein the first visual indicator is a shape object and different types of work items have different shape objects.

3. The system of claim 1, wherein the second visual indicator is a size of the first visual indicator such that a first work object having a larger size of the first visual indicator compared to a second work object indicates that the first work object has a higher cost of delay compared to the second work object.

4. The system of claim 1, wherein the third visual indicator is a color of the first work object such that a first work object having a different color of the first visual indicator compared to a second work object indicates that the first work object has a different cost of delay profile compared to the second work object.

5. The system of claim 1, wherein the fourth visual indicator is a line such that first visual indicators for a first work item and a second work item have a line connecting both of the first visual indicators to represent a dependency relationship between the first work item and the second work item.

6. The system of claim 5, wherein a thickness of the line indicates strength of dependency such that a thicker line represents a stronger dependency than a thinner line.

7. The system of claim 5, wherein the line is directional indicating a specific direction of dependency.

8. The system of claim 1, further configured to receive, from the client device, a change in dependency between two work items that previously had no dependency relationship.

9. The system of claim 8, further configured to perform a risk analysis in response to the change in dependency to determine whether affected work items are at no risk or at high risk.

10. The system of claim 9, further configured to perform the risk analysis based on five attributes including the cost of delay for a respective work item, a number of dependencies for the respective work item, a current status of the respective work item, a percentage work remaining for completing the work item, and a number of days that the work item is blocked.

11. The system of claim 10, wherein a machine learning model taking in as input the five attributes for each work item provides an output indicating whether any of the work items are at no risk or at high risk.

12. The system of claim 11, wherein the machine learning model is trained based on a K nearest neighbor algorithm.

13. The system of claim 1, further configured to:
track backlogged work items;
determine, based on weighted shorted jobs first algorithm, a recommended order for tackling the backlogged work items; and
provide the recommended order to the client device.

14. A method for displaying an organization model, comprising:
retrieving work items from storage, each work item including at least one requirement;
determining, for each of the work items, one or more dependencies;
determining a relative ranking of costs for the work items; and
providing, to a client device, visualization parameters for representing the work items,
wherein for a respective work item, the visualization parameters include a first visual indicator representing a type of work item, a second visual indicator representing a cost of delay associated with the work item, and a third visual indicator representing a cost of delay profile for the work item, and
wherein the visualization parameters further include a fourth visual indicator for linking pairs of work items to indicate a dependency between the linked work items.

15. The method of claim 14, wherein the first visual indicator is a shape object and different types of work items have different shape objects.

16. The method of claim 14, wherein the second visual indicator is a size of the first visual indicator such that a first work object having a larger size of the first visual indicator compared to a second work object indicates that the first work object has a higher cost of delay compared to the second work object.

17. The method of claim 14, wherein the third visual indicator is a color of the first work object such that a first work object having a different color of the first visual indicator compared to a second work object indicates that the first work object has a different cost of delay profile compared to the second work object.

18. The method of claim 14, wherein the fourth visual indicator is a line such that first visual indicators for a first work item and a second work item have a line connecting both of the first visual indicators to represent a dependency relationship between the first work item and the second work item.

19. The method of claim 18, wherein a thickness of the line indicates strength of dependency such that a thicker line represents a stronger dependency than a thinner line.

20. A client device for displaying an organization model, the client device including a non-transitory computer-readable medium storing computer-executable instructions thereon such that when the instructions are executed, the client device is configured to:
receive one or more work items from a server;
receive, from the server, visualization parameters for representing the one or more work items,
wherein for a respective work item, the visualization parameters include a first visual indicator representing a type of work item, a second visual indicator representing a cost of delay associated with the work item, and a third visual indicator representing a cost of delay profile for the work item, and
wherein the visualization parameters further include a fourth visual indicator for linking pairs of work items to indicate a dependency between the linked work items; and
displaying the work items on a screen of the client device according to the visualization parameters and one or more visualization settings, wherein the visualization settings include hiding work items of a certain type, work items of a certain cost of delay, work items of a certain cost of delay profile, or any combination thereof.
